(19) United States
(12) Patent Application Publication
(10) Pub. No.: US 2015/0155963 A1
(43) Pub. Date: Jun. 4, 2015

(54) Upscaling 20G Optical Transceiver Module

(71) Applicant: Cisco Technology, Inc., San Jose, CA (US)

(72) Inventors: Norman Tang, Los Altos, CA (US); Liang Ping Peng, Santa Clara, CA (US); David Lai, Mountain View, CA (US); Anthony Nguyen, San Jose, CA (US); Steven A. Hanssen, San Jose, CA (US)

(73) Assignee: Cisco Technology, Inc., San Jose, CA (US)

(21) Appl. No.: 14/096,392

(22) Filed: Dec. 4, 2013

(51) Int. Cl. H04J 14/02; H04L 7/00; H04B 10/40

(52) U.S. Cl. CPC H04J 14/0205; H04B 10/40; H04L 7/0075

(57) ABSTRACT

An upscaling transceiver module is provided that is configured to provide data connectivity between transceiver modules. The upscaling transceiver module comprises a first connector and a second connector. The first connector is configured to interface with a first port of a host device, and the second connector is configured to interface with a second port of a second host device. The connectors support exchange of 10G signals. The upscaling transceiver module also comprises a multiplexing unit and a demultiplexing unit. The multiplexing unit receives a first and second 10G transmission signals. The multiplexing unit combines the first and second 10G transmission signals into a twenty gigabit per second (20G) transmission signal. The demultiplexing unit obtains a 20G receive signal from a system device and splits the 20G receive signal into first and second 10G receive signals.

### TECHNICAL FIELD

The present disclosure relates to techniques for upscaling communications of Enhanced Small Form-Factor Pluggable (SFP+) modules.

### BACKGROUND

Multiple Source Agreement (MSA) specifications for a Small Form-Factor Pluggable (SFP) and an enhanced SFP (SFP+) transceiver module define a hot-pluggable transceiver module that is used to support communications at a data rate of ten gigabits per second (10G) using one or more communication standards. Additionally, MSA specifications for a Quad Small Form-Factor Pluggable (QSFP) transceiver module and an enhanced QSFP transceiver module (QSFP+) define a hot-pluggable module that integrates four transmit and four receive 10G channels with a standard multi-fiber push-on (MPO) parallel optical connector for high-density applications. QSFP and QSFP+ transceiver modules enable data communications at a data rate of up to forty gigabits per second (40G). For example, the QSFP+ transceiver module may send and receive 40G data across four 10G data paths.

### BRIEF DESCRIPTION OF THE DRAWINGS

FIG. 1 shows an example assembly of a plurality of upscaling transceiver modules that are each configured to interface with a plurality of host devices and a system device.

FIG. 2 shows an example of the plurality of upscaling transceiver modules with first ends and second ends to enable data connectivity between the host devices and the system device.

FIG. 3 shows an example of the upscaling transceiver modules each configured with multiplexing units that combine data signals and also configured with demultiplexing units that split data signals.

FIGS. 4A and 4B show example diagrams depicting operations of the multiplexing units of the upscaling transceiver modules.

FIGS. 5A and 5B show example diagrams depicting operations of the demultiplexing units of the upscaling transceiver modules.

FIG. 6 shows an example flow chart depicting operations for upscaling data communications to provide data connectivity between the host devices and the system device.

### DESCRIPTION OF EXAMPLE EMBODIMENTS

### Overview

An upscaling transceiver module is provided that is configured to provide data connectivity between devices. The upscaling transceiver module comprises a first connector and a second connector. The first connector is configured to interface with a first port of a host device to support exchange of a ten gigabit per second (10G) signal between the first host device and the first connector via the first port. The second connector is configured to interface with a second port of a second host device to support exchange of a 10G signal between the second host device and the second connector via the second port. The upscaling transceiver module also comprises a multiplexing unit and a demultiplexing unit. The multiplexing unit is configured to receive a first 10G transmission signal from the first connector and to receive a second 10G transmission signal from the second connector. The multiplexing unit combines the first 10G transmission signal and the second 10G transmission signal into a twenty gigabit per second (20G) transmission signal. The demultiplexing unit obtains a 20G receive signal from a system device and splits the 20G receive signal into a first 10G receive signal and a second 10G receive signal. The demultiplexing unit couples the first 10G receive signal to the first connector and couples the second 10G receive signal to the second connector.

### Example Embodiments

The techniques presented herein relate to enabling data communications between a plurality of host devices and a system device via one or more upscaling transceiver modules. In general, the upscaling transceiver modules provide data connectivity between host devices configured to support ten gigabit per second (10G) data and system devices configured to support forty gigabit per second (40G) data.

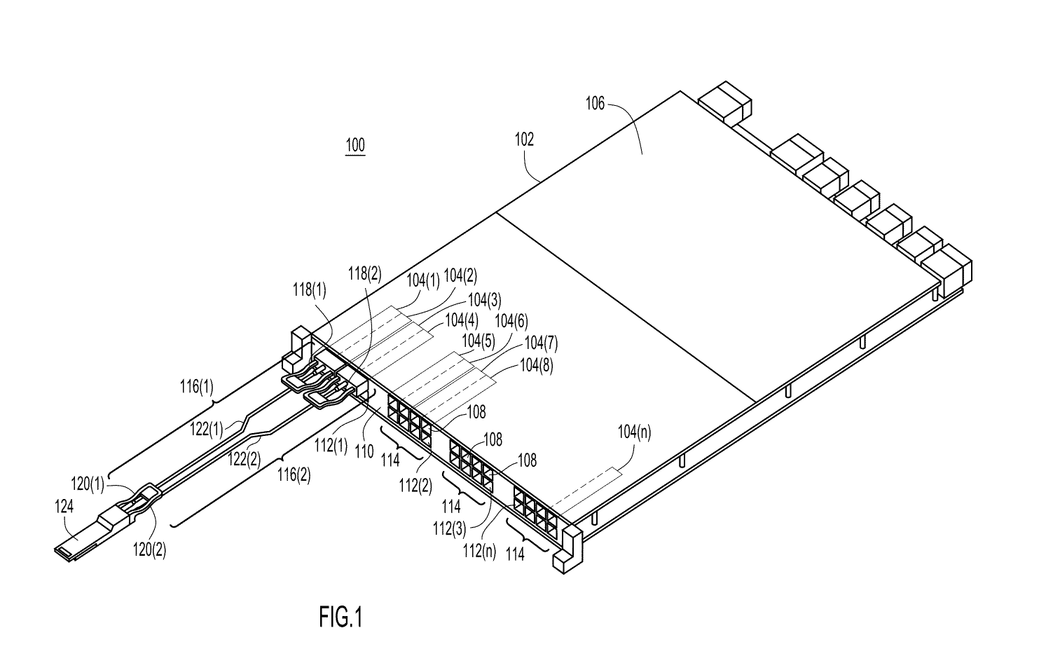

An example assembly is illustrated in FIG. 1 at reference numeral 100. FIG. 1 shows a host unit 102, which houses a plurality of host devices. The host devices are shown at reference numerals 104(1)-104(n). It should be appreciated that the host devices 104(1)-104(n) reside within the host unit 102, and thus, in one example, these host devices 104(1)-104(n) reside beneath a top surface 106 of the host unit 102. Thus, the host devices 104(1)-104(n) may not be visible from outside of the host unit 102.

Each of the host devices 104(1)-104(n) has a corresponding port. The ports are shown generally at reference numeral 108. It should be appreciated that each port corresponds to one host device. That is, each host device has a single port. The host unit 102 has a side surface 110, and the side surface 110 has a plurality of housings, shown at reference numerals 112(1)-112(m). Groups of ports, shown at reference numeral 114, reside in the housings 110(1)-110(m) such that each of the ports is accessible by devices external to the host unit 102. For example, as shown in FIG. 1, each group of ports may comprise eight ports that are a part of eight corresponding host devices.

FIG. 1 also shows a plurality of upscaling transceiver modules. The upscaling transceiver modules are shown at reference numerals 116(1) and 116(2). As described in detail hereinafter, each of the upscaling modules 116(1) and 116(2) has a first end assembly (also referred to hereinafter as a “host end”) and a second end assembly (e.g., a “system end”). The host ends are shown at reference numerals 118(1) and 118(2), and the system ends are shown at reference numerals 120(1) and 120(2). The host ends 118(1) and 118(2) are connected to the system ends 120(1) and 120(2) via respective cables 122(1) and 122(2). Each of the host ends 118(1) and 118(2) is configured to interface with a plurality of ports of the host devices in the host unit 102. In FIG. 1, the host ends 118(1) and 118(2) each interface with two ports. Also, each of the system ends 120(1) and 120(2) is configured to interface with ports of a system device. The system device is shown at reference numeral 124 in FIG. 1. Thus, each of the upscaling transceiver modules 116(1) and 116(2) enables data communications to be exchanged between a plurality of the host devices and the system device 124.

Communications may be exchanged from a plurality of the host devices to the system device 124 via the upscaling transceiver modules 116(1) and 116(2). These communications are referred to hereinafter as “host-to-system” communications. Likewise, communications may be exchanged from the system device 124 to the plurality of host devices via the upscaling transceiver modules 116(1) and 116(2). These communications are referred to hereinafter as “system-to-host” communications. In one example, the host devices 104(1)-104(n) may be enhanced SFP (SFP+) transceiver modules that are configured to send and receive 10G data. The system device 124 may be a Quad Small Form-Factor Pluggable (QSFP) or enhanced QSFP (QSFP+) transceiver module that is configured to send and receive 40G data. Thus, as described by the techniques herein, each of the upscaling transceiver modules 116(1) and 116(2) enable two SFP+ host devices to exchange host-to-system communications and system-to-host communications with a QSFP or QSFP+ system device. As a result, when two upscaling transceiver modules are connected to corresponding host devices and the system device 124, the combined use of the upscaling transceiver modules enables 4×10G host-to-system communications from four SFP+ host devices to a single QSFP or QSFP+ system device and also enables 4×10G system-to-host communications from a single QSFP or QSFP+ system device to four SFP+ host devices.

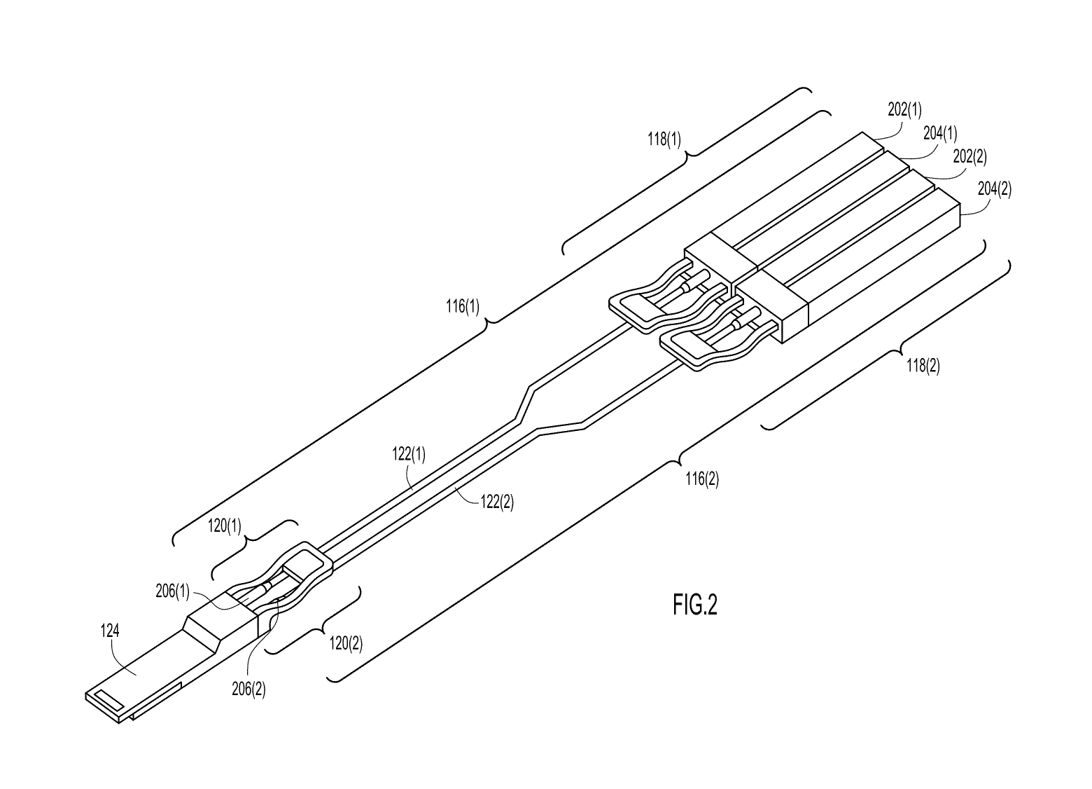

Reference is now made to FIG. 2. FIG. 2 shows each of the upscaling transceiver modules 116(1) and 116(2) in more detail with continued reference to FIG. 1. As described above, each of the upscaling transceiver modules 116(1) and 116(2) has a host end and a system end. The host end is shown at reference numeral 118(1) for the first upscaling transceiver module 116(1) and at reference numeral 118(2) for the second upscaling transceiver module 116(2). The system end for the first upscaling transceiver module 116(1) is shown at 120(1) and at 120(2) for the second upscaling transceiver module 116(2). The host ends 118(1) and 118(2) are connected to the corresponding system ends 120(1) and 120(2) via cables 122(1) and 122(2). The cables 122(1) and 122(2) are fiber optic cables.

Each of the host ends 118(1) and 118(2) has two connectors. As shown in FIG. 2, the host end 118(1) has a first connector 202(1) and a second connector 204(1). Likewise, the host end 118(2) has a first connector 202(2) and a second connector 204(2). The connectors 202(1), 202(2), 204(1) and 204(2) may also be referred to herein as “host connectors.” Each host connector is configured to interface with (e.g., “plug into”) ports of corresponding host devices of the host unit 102. For example, connector 202(1) is configured to plug into a port of a first host device (e.g., host device 104(1)) and connector 204(1) is configured to plug into a port of a second host device (e.g., host device 104(2)). Likewise, connector 202(2) is configured to plug into a port of a third host device (e.g., host device 104(3)) and connector 204(2) is configured to plug into a port of a fourth host device (e.g., host device 104(4)). Thus, the upscaling transceiver module 116(1) is configured to send and receive data communications to two host devices via the connectors 202(1) and 204(1), and the upscaling transceiver module 116(2) is also configured to send and receive data communications to two host devices via the connectors 202(2) and 204(2).

Each of the system ends 120(1) and 120(2) also has a connector. As shown in FIG. 2, the system end 120(1) has a first connector 206(1), and the system end 120(2) has a second connector 206(2). The connectors 206(1) and 206(2) are also referred to herein as “system connectors.” The system connectors are configured to plug into ports of a single system device, shown at reference numeral 124 in FIG. 2. For example, connector 206(1) of the first upscaling transceiver module 116(1) is configured to interface with or plug into a first port of the system device 124, and connector 206(2) is configured to plug into a second port of the same system device 124. The ports of the system device 124 are not shown in FIG. 2.

The first upscaling transceiver module 116(1) and the second upscaling transceiver module 116(2) are configured to enable host-to-system communications and system-to-host communications between host devices 104(1)-104(4) (shown in FIG. 1) and the system device 124. That is, when the host connectors 202(1) and 204(1) plug into ports of corresponding host devices 104(1) and 104(2) and when the system connector 206(1) plugs into a port of the system device 124, host devices 104(1) and 104(2) can each send host-to-system communications to the system device 124 via the first upscaling transceiver module 116(1) and can receive system-to-host communications form the system device 124 via the first upscaling module 116(1). Likewise, when the host connectors 202(2) and 204(2) plug into ports of corresponding host devices 104(3) and 104(4), and when system connector 206(2) plugs into a port of the system device 124, host devices 104(3) and 104(4) can each send host-to-system communications and can receive system-to-host communications via the second upscaling module 116(2).

In the example where the host devices 104(1)-104(4) are SFP+ transceiver modules and where the system device 124 is a QSFP or QSFP+ transceiver module, each of the upscaling transceiver modules 116(1) and 116(2) enables 2×10G bidirectional data communications to be exchanged between host devices and the system device 124. Thus, in this example, two upscaling transceiver modules may be used to enable 40G communications between the host devices 104(1)-104(4) and the system device 124. That is, for host-to-system communications, the first upscaling transceiver module 116(1) receives a 10G signal from host device 104(1) and another 10G signal from host device 104(2) and combines (e.g., “upscales”) the two 10G signals into a 20G signal. Likewise, the second upscaling transceiver module 116(2) receives 10G signals from the host devices 104(3) and 104(4) and combines the two 10G signals into a 20G signal. Together, the first upscaling transceiver module 116(1) and the second upscaling transceiver module 116(2) send a 2×20G signal to the system device 124. For system-to-host communications, the system device 124 sends a 20G signal to the first upscaling transceiver module 116(1) and sends a second 20G signal to the second upscaling transceiver module 116(2). The upscaling transceiver modules 116(1) and 116(2) each split the 20G signals into two 10G signals, and send the 10G signals to corresponding host devices.

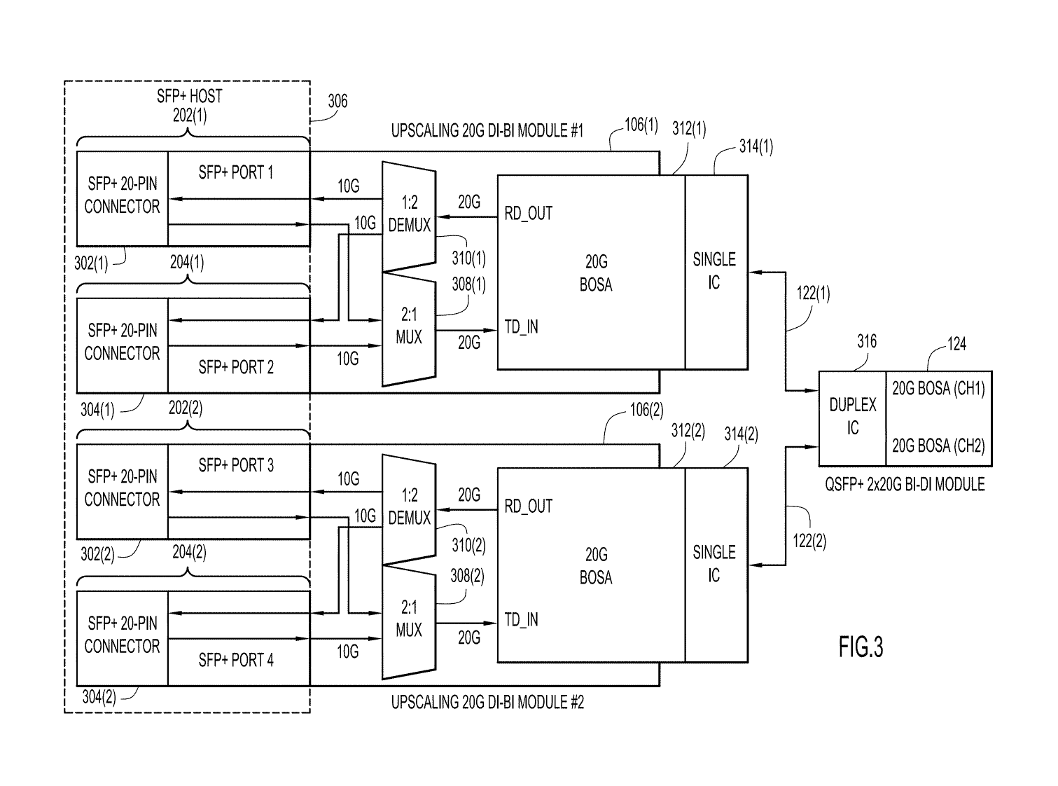

Reference is now made to FIG. 3. FIG. 3 shows the upscaling transceiver modules 116(1) and 116(2). The internal components of each upscaling transceiver module are the same. For simplicity, FIG. 3 is described with respect to upscaling transceiver module 116(1), though it should be appreciated that the upscaling transceiver module 116(2) has similar components that are labeled with similar reference numerals with index “(2)”. FIG. 3 shows the host connectors 202(1) and 204(1). Each of the host connectors 202(1) and 204(1) has pin connectors, shown at reference numerals 302(1) and 304(1). The pin connectors 302(1) and 304(1) are, for example, 20-pin SFP+ connectors configured to interface with pins of the respective SFP+ host devices 104(1) and 104(2). As stated above, the host connectors 202(1) and 204(1) each plug into a port of a corresponding host device. Thus, in FIG. 3, the portions of the upscaling transceiver module 116(1) that are inside the box 306 represent portions that are plugged into ports of corresponding host devices. The portions outside of the box 306 are outside of the ports (and thus, outside of the host unit 102 shown in FIG. 1).

Once plugged in, each of the host connectors 202(1) and 204(1) are configured to send and receive 10G signals from the host devices of the ports to which they are connected. For host-to-system communications originating from the host devices, the 10G signals are configured to be sent from the host connectors 202(1) and 204(1) to a multiplexing unit 308(1). Likewise, for system-to-host communications destined for the host devices, the 10G signals are configured to be sent to the host connectors 202(2) and 204(2) from a demultiplexing unit 310(1). The multiplexing unit 308(1) is a 2:1 multiplexing unit that is configured to combine two 10G signals originating from the host devices into a single 20G signal. The demultiplexing unit 310(1) is a 1:2 demultiplexing unit that is configured to split a 20G signal originating from the system device 124 into two 10G signals. It should be appreciated that 10G signals originating from host devices may also be referred to as “10G transmission signals” and also that the 20G signal resulting from multiplexing two 10G transmission signals may be referred to as a “20G transmission signal.” Likewise, the 20G signal originating from the system device 124 may be referred to as a “20G receive signal,” and also, the two 10G signals resulting from demultiplexing the 20G receive signal may be referred to as “10G receive signals.”

The multiplexing unit 308(1) is coupled to a Bidirectional Optical Sub-Assembly (BOSA) unit 312(1) via a transmission “in” (or “TD in”) path. Additionally, the demultiplexing unit 310(1) is also coupled to the BOSA unit 312(1) via a receiving “out” (or “RD_out”) path. The BOSA unit 312(1) interfaces with an optical connector 314(1), which connects to the cable 122(1). The cable 122(1) may be, for example, a single mode fiber, bidirectional (BiDi) optical cable. The optical connector 314(1) may be a conventional SFP 10G BiDi optical connector for connecting to a single mode fiber patch cable. The cable 122(1) ultimately connects to the system device 124 via the system connector 120(1) (not shown in FIG. 3). The system device 124 has a dual mode optical fiber connector 316 and two 20G BOSA channels. Thus, the upscaling transceiver module 116(1) is configured to receive two 10G transmission signals from corresponding host devices and to combine them into a single 20G transmission signal to be sent to the system device 124. Likewise, the upscaling transceiver module 116(1) is also configured to receive a 20G receive signal from the system device 124 and to split it into two 10G receive signals to be sent to corresponding host devices. The system device 124 may receive another 20G transmission signal from the other upscaling transceiver module 116(2) and may send another 20G receive signal to the other upscaling transceiver module 116(2), thus enabling 40G data communications (2×20G bidirectional data) to be sent between four host devices and the system device 124.

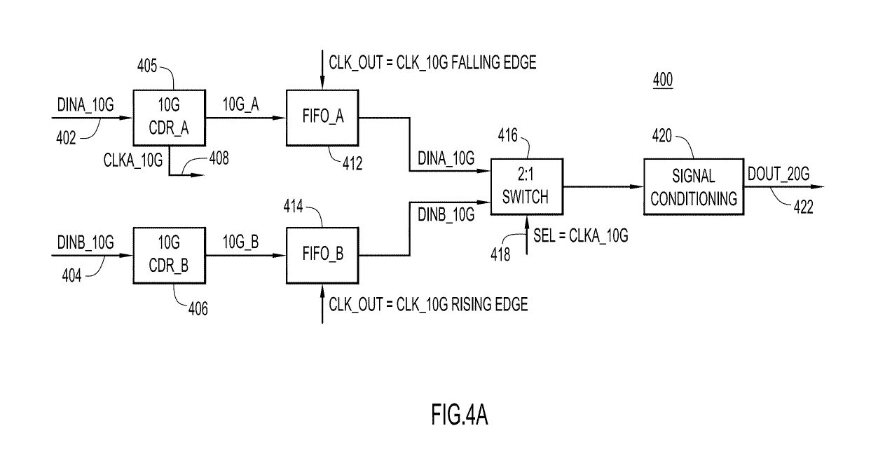

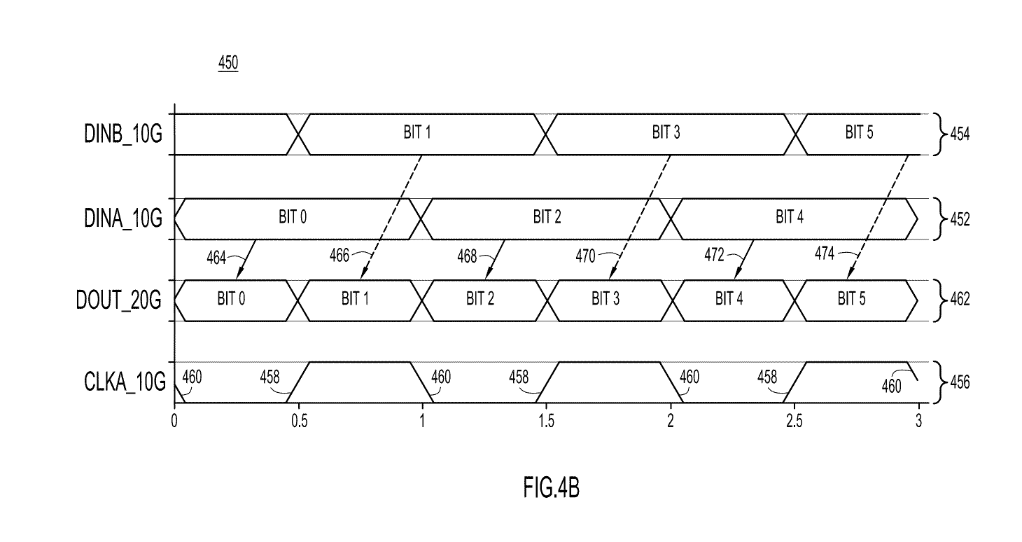

Reference is now made to FIGS. 4A and 4B, which show diagrams depicting components and operations of the multiplexing unit, e.g., multiplexing unit 308(1). It should be appreciated that the diagrams may also represent the operations multiplexing unit 308(2) of the upscaling transceiver module 106(2). FIG. 4A shows at 400 components of the multiplexing unit 308(1), while FIG. 4B shows at 450 an example of signals associated with the multiplexing operations. It should be appreciated that the multiplexing unit 308(1) and 308(2) may be bit-wise multiplexers that multiplex bits of a first 10G transmission signal with bits of a second 10G transmission signal, as described herein.

In FIG. 4A, the multiplexing unit 308(1) has a first 10G input and a second 10G input. The first 10G input may also be referred to as “DINA_{—}10G” and is shown at reference numeral 402. The second 10G input may be referred to as “DINB_{—}10G” and is shown at reference numeral 404. At any given interval of time, DINA_{—}10G and DINB_{—}10G each comprises several bits, as shown at reference numerals 452 and 454 in FIG. 4B. For example, during a given time period, DINA_{—}10G is shown at 452 comprising three bits labeled “Bit 0,” “Bit 2,” and “Bit 4.” DINB_{—}10G is shown at 454 comprising three bits as well, labeled “Bit 1,” “Bit 3,” and “Bit 5.”

DINA_{—}10G is sent to a first Clock Data Recovery (CDR) unit 405, and DINB_{—}10G is sent to a second CDR unit 406 and a second CDR unit 406. The first CDR unit 405 is also referred to as “10G CDR_A” and the second CDR unit 406 is also referred to as “10G CDR_B.” 10G CDR_A receives DINA_{—}10G from a host device via a first host connector, and 10G CDR_B receives DINB_{—}10G from a host device via a second host connector. The 10G CDR_A generates a recovered clock signal from DINA_{—}10G at, e.g., 10 GHz. This clock signal is also referred to as “CLKA_{—}10G” and is shown at reference numeral 408 in FIG. 4A. CLKA_{—}10G is shown in FIG. 4B at 456 with rising edges 458 and falling edges 460.

After generating CLKA_{—}10G, the 10G CDR_A sends the modified signal 10G _A to a first First-In First-Out (FIFO) module 412. The 10G CDR_B sends the modified signal 10G_B to a second FIFO module 414. The first FIFO module 412 is referred to as “FIFO_A” and the second FIFO module 414 is referred to as “FIFO_B.” FIFO_A clocks data in using recovered CLKA_{—}10G from CDR_A and clocks data out at the falling edges of CLKA_{—}10G. Likewise, FIFO_B clocks data in using CLKA_{—}10G and clocks data out at the rising edges of CLKA_{—}10G. DINA_{—}10G and DINB_{—}10G (which may be synchronized 10G_A and 10G_B signals) are then sent to a 2:1 switch unit, shown at 416.

It is assumed that the frequency of the channel for DINA_{—}10G is synchronized with the channel for DINB 10G. The 2:1 switch unit 416 selects bit components from either 10G_A or 10G_B to generate an output signal. The output signal is based on a selection signal (“Sel”), as shown at reference numeral 418 in FIG. 4A. When Sel=0, the 2:1 switch unit 416 will select a bit from 10G_A for an output signal. When Sel=1, the 2:1 switch unit 416 will select a bit unit from 10G_B for the output signal. This operation is shown in FIG. 4B at 462. In FIG. 4B, bit 0 from 10G A is selected at 464 for the time that CLKA_{—}10G (shown at 456) has an output value of 0. Bit 1 from 10G _B is subsequently selected at 466 for the time that CLKA 10G has an output value of 1. Likewise, bit 2 is selected at 468 from 10G_A, bit 3 is selected at 470 from 10G_B, bit 4 is selected from 10G_A at 472 and bit 5 is selected at 474 from 10G_B. Thus, the output of the 2:1 switch unit 416 comprises multiplexed bits that are alternately selected from both 10G_A and 10G_B. The output is sent to a signal conditioning unit 420 to perform operations including, e.g., filtering, CDR, flip-flop, de-emphasis, etc. The signal conditioning unit 420 outputs the final 20G transmission signal, which ultimately will be sent to the system device 124. The 20G transmission signal is also referred to as “DOUT_{—}20G” and is shown at 422 in FIG. 4A.

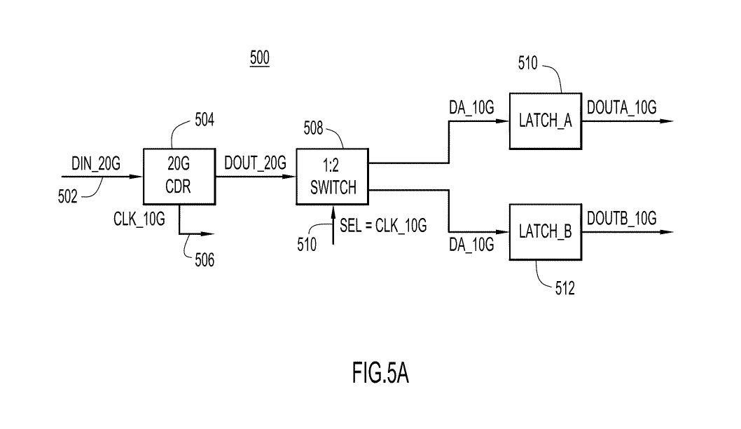

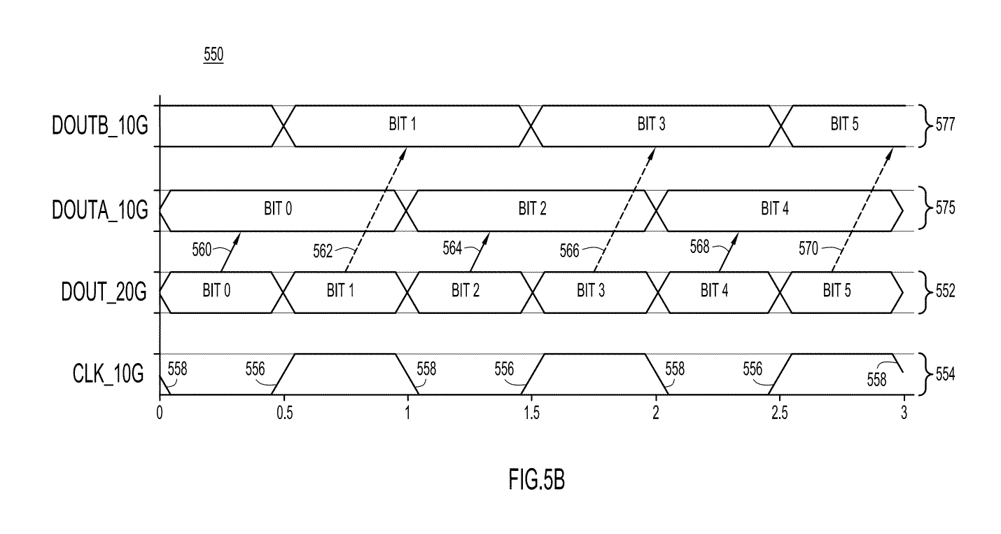

Reference is now made to FIGS. 5A and 5B, which show diagrams depicting components and operations of the demultiplexing unit 310(1). It should be appreciated that the diagrams may also represent the demultiplexing unit 310(2) of the upscaling transceiver module 106(2). FIG. 5A shows at 500 components of the demultiplexing unit 310(2), while FIG. 5B shows at 550 an example of the demultiplexing operations. The demultiplexing units 310(1) and 310(2) are bit-wise demultiplexers that demultiplex bits from a 20G receive signal, as described herein.

In FIG. 5A, the demultiplexing unit 310 has an input referred to as “DIN_{—}20G.” The input is shown at reference numeral 502. DIN_{—}20G may be a 20G signal received from the system device 124. DIN_{—}20G is sent to a 20G CDR unit 504, which is shown at reference 504. The 20G CDR unit 504 modifies a bit rate of the 20G receive signal to create an output signal, referred to as “DOUT_{—}20G.” Additionally, as shown at 506, the 20G CDR unit 504 generates a clock signal, referred to as “CLK_{—}10G.” The clock signal is a signal that is recovered at half the rate as the original DIN_{—}20G signal (e.g., a 10G clock rate for a 20G signal). DOUT_{—}20G is shown in FIG. 5B at 552, and as shown, DOUT_{—}20G comprises several bits during a given time period. CLK_{—}10G is also shown in FIG. 5B at 554. CLK_{—}10G has rising edges 556 and falling edges 558. DOUT_{—}20G is sent to a 1:2 switch unit 508. The 1:2 switch unit 508 selects bit components from DOUT_{—}20G and splits those components into a separate output signal based on a selection signal (“Sel”) shown at reference numeral 510. For example, the selection signal is set to CLK_{—}10K, and when Sel=0, the 1:2 switch unit 508 adds a bit from DOUT_{—}20G to a first output signal (“DA_{—}10G”). When Sel=1, the 1:2 switch unit 508 adds a bit from DOUT_{—}20G to a second output signal (“DB_{—}10G”). DA_{—}10G and DB_{—}10G are then further modified to generate final 10G output signals DOUTA_{—}10G and DOUTB_{—}10G. DOUTA_{—}10G is shown at reference numeral 575 in FIG. 5B, and DOUTB_{—}10G is shown at reference numeral 577 in FIG. 5B.

For example, as shown in FIG. 5B, bit 0 of DOUT_{—}20G is first selected at 560 for DOUTA_{—}10G (when CLK_{—}10G=0), and bit 1 of DOUT_{—}20G is selected at 562 for DOUTB_{—}10G (when CLK_{—}10G=1). Likewise, bit 2 is selected for DOUTA_{—}10G at 564, bit 3 is selected for DOUTB_{—}10G at 566, bit 4 is selected for DOUTA_{—}10G at 568 and bit 5 is selected for DOUTB_{—}10G at 570. In one example, the 1:2 switch unit 508 will operate as a digital flip-flop (DFF) to alternate selection of bits to be added to DOUTA_{—}10G and DOUTB_{—}10G. In another example, latch units 510 and 512 may be used to modify the output of the 1:2 switch unit 508. Ultimately, DOUTA_{—}10G (e.g., the first 10G receive signal) is sent to a first host device (e.g., an SFP+ host device) and DOUTB_{—}10G (e.g., the second 10G receive signal) is sent to a second host device.

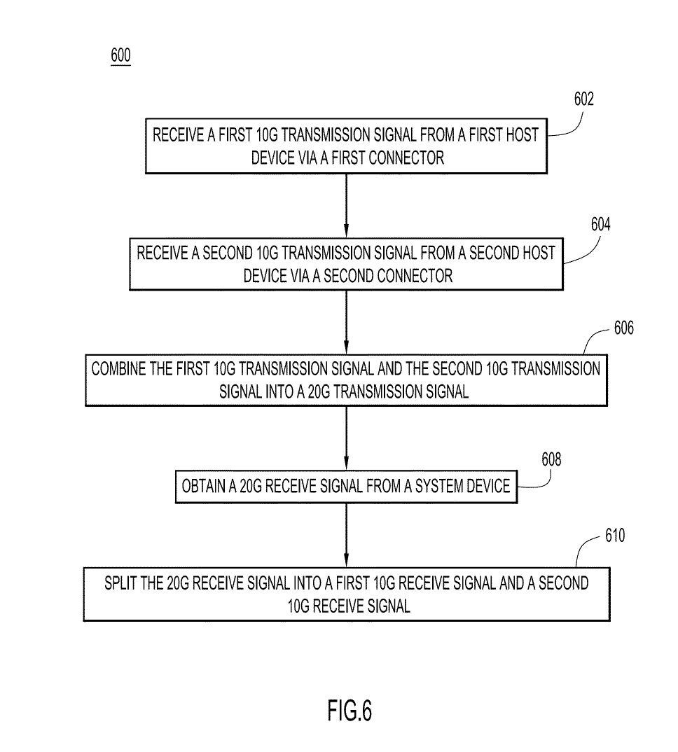

Reference is now made to FIG. 6, which shows an example flow chart 600 depicting operations for upscaling data communications to provide data connectivity between the host devices 104(1)-104(4) and the system device 124, as depicted in FIGS. 1-3. At reference numeral 602, an upscaling transceiver module receives a first 10G transmission signal from a first host device via a first connector. The upscaling transceiver module, at 604, receives a second 10G transmission signal from a second host device via a second connector. At 606, the first 10G transmission signal and the second 10G transmission signal are combined into a 20G transmission signal. At 608, the upscaling transceiver module obtains a 20G receive signal from a system device, and at 610, the 20G receive signal is split into a first 10G receive signal and a second 10G receive signal.

It should be appreciated that the techniques described above in connection with all embodiments may be performed by one or more computer readable storage media that is encoded with software comprising computer executable instructions to perform the methods and steps described herein. For example, the operations performed by the upscaling transceiver module 106 may be performed by one or more computer or machine readable storage media or device executed by a processor and comprising software, hardware or a combination of software and hardware to perform the techniques described herein.

In summary, an apparatus is provided comprising: a first connector configured to interface with a first port of a host device to support exchange of a ten gigabit per second (10G) signal between the first host device and the first connector via the first port; a second connector configured to interface with a second port of a host device to support exchange of a 10G signal between the second host device and the second connector via the second port; a multiplexing unit configured to: receive a first 10G transmission signal from the first connector; receive a second 10G transmission signal from the second connector; and combine the first 10G transmission signal and the second 10G transmission signal into a twenty gigabit per second (20G) transmission signal; and a demultiplexing unit configured to: obtain a 20G receive signal from a system device; split the 20G receive signal into a first 10G receive signal and a second 10G receive signal; couple the first 10G receive signal to the first connector; and couple the second 10G receive signal to the second connector.

In addition, a method is provided comprising: at a transceiver module, receiving a first ten gigabit per second (10G) transmission signal from a first host device via a first connector; receiving a second 10G transmission signal from a second host device via a second connector; combining the first 10G transmission signal and the second 10G transmission signal into a twenty gigabit per second (20G) transmission signal; obtaining a 20G receive signal from a system device; and splitting the 20G receive signal into a first 10G receive signal and a second 10G receive signal.

Furthermore, a system is provided comprising: a plurality of host devices configured to send and receive ten gigabit per second (10G) data; a transceiver module comprising: a first connector configured to interface with a first port of a first one of the host devices to support exchange of 10G signal between the first host device and the first connector via the first port; a second connector configured to interface with a second port of a second one of the host devices to support exchange of 10G signal between the second host device and the second connector via the second port; a multiplexing unit configured to: receive a first 10G transmission signal from the first connector; receive a second 10G transmission signal from the second connector; and combine the first 10G transmission signal and the second 10G transmission signal into a twenty gigabit per second (20G) transmission signal; and a demultiplexing unit configured to: obtain a 20G receive signal from a device in communication with the transceiver module; split the 20G receive signal into a first 10G receive signal and a second 10G receive signal; couple the first 10G receive signal to the first connector; and couple the second 10G receive signal to the second connector; and a system device configured to send and receive 20G data to the transceiver module.

The above description is intended by way of example only. Various modifications and structural changes may be made therein without departing from the scope of the concepts described herein and within the scope and range of equivalents of the claims.

What is claimed is:

1. An apparatus comprising:
a first connector configured to interface with a first port of a host device to support exchange of a ten gigabit per second (10G) signal between the first host device and the first connector via the first port;
a second connector configured to interface with a second port of a host device to support exchange of a 10G signal between the second host device and the second connector via the second port;
a multiplexing unit configured to:
receive a first 10G transmission signal from the first connector;
receive a second 10G transmission signal from the second connector; and
combine the first 10G transmission signal and the second 10G transmission signal into a twenty gigabit per second (20G) transmission signal; and
a demultiplexing unit configured to:
obtain a 20G receive signal from a system device;
split the 20G receive signal into a first 10G receive signal and a second 10G receive signal;
couple the first 10G receive signal to the first connector; and
couple the second 10G receive signal to the second connector.

2. The apparatus of claim 1, wherein the first connector is configured to interface with a first enhanced Small Form-Factor Pluggable (SFP+) host port and wherein the second connector is configured to interface with a second SFP+ host port.

3. The apparatus of claim 1, further comprising a system interface unit that is configured to:
transmit the 20G transmission signal to a Quad-Small Form-Factor Pluggable (QSFP) system device; and
receive the 20G receive signal from the QSFP system device system device.

4. The apparatus of claim 1, wherein the multiplexer unit is a bit-wise multiplexer unit that is configured to multiplex bits of the first 10G transmission signal with bits of the second 10G transmission signal.

5. The apparatus of claim 4, wherein the multiplexer unit further comprises:
a first clock data recovery unit configured to recover clock and data of the first 10G transmission signal; and
a second clock data recovery unit configured to recover clock and data of the second 10G transmission signal.

6. The apparatus of claim 1, wherein the demultiplexer unit is a bit-wise demultiplexer unit that is configured to demultiplex bits from the 20G receive signal.

7. The apparatus of claim 6, wherein the demultiplexer unit further comprises a clock data recovery unit configured to recover clock and data of the 20G receive signal.

8. A method comprising:
at a transceiver module, receiving a first ten gigabit per second (10G) transmission signal from a first host device via a first connector;
receiving a second 10G transmission signal from a second host device via a second connector;
combining the first 10G transmission signal and the second 10G transmission signal into a twenty gigabit per second (20G) transmission signal;
obtaining a 20G receive signal from a system device; and
splitting the 20G receive signal into a first 10G receive signal and a second 10G receive signal.

9. The method of claim 8, further comprising:
coupling the 20G transmission signal to an Quad-Small Form-Factor Pluggable (QSFP) system device;
coupling the first 10G receive signal to a first enhanced Small Form-Factor Pluggable (SFP+) host device; and
coupling the second 10G receive signal to a second enhanced SFP+ host device.

10. The method of claim 8, wherein:
receiving the first 10G transmission signal comprises receiving the first 10G transmission signal from a first enhanced Small Form-Factor Pluggable (SFP+) host device;
receiving the second 10G transmission signal comprises receiving the second 10G transmission signal from a second SFP+ device; and
obtaining the 20G receive signal comprises receiving the 20G receive signal from an Quad-Small Form-Factor Pluggable (QSFP) system device.

11. The method of claim 8, wherein combining comprises multiplexing bits of the first 10G transmission signal with bits of the second 10G transmission signal.

12. The method of claim 11, wherein multiplexing comprises modifying a first bit rate of the first 10G transmission signal and modifying a second bit rate of the second 10G transmission signal.

13. The method of claim 8, wherein splitting comprises demultiplexing bits from the 20G receive signal.

14. The method of claim 13, wherein demultiplexing comprises modifying a bit rate of the 20G receive signal using a clock data recovery unit.

15. A system comprising:
a plurality of host devices configured to send and receive ten gigabit per second (10G) data;
a transceiver module comprising:
a first connector configured to interface with a first port of a first one of the host devices to support exchange of 10G signal between the first host device and the first connector via the first port;
a second connector configured to interface with a second port of a second one of the host devices to support exchange of 10G signal between the second host device and the second connector via the second port;
a multiplexing unit configured to:
receive a first 10G transmission signal from the first connector;
receive a second 10G transmission signal from the second connector; and
combine the first 10G transmission signal and the second 10G transmission signal into a twenty gigabit per second (20G) transmission signal; and
a demultiplexing unit configured to:
obtain a 20G receive signal from a device in communication with the transceiver module;
split the 20G receive signal into a first 10G receive signal and a second 10G receive signal;
couple the first 10G receive signal to the first connector; and
couple the second 10G receive signal to the second connector; and
a system device configured to send and receive 20G data to the transceiver module.

16. The system of claim 15, wherein the host devices are enhanced Small Form-Factor Pluggable (SFP+) devices and wherein the system device is a Quad-Small Form-Factor Pluggable (QSFP) device.

17. The system of claim 16, wherein the transceiver module further comprises a system interface unit that is configured to:
transmit the 20G transmission signal to the QSFP system device; and
receive the 20G receive signal from the QSFP system device system device.

18. The system of claim 15, wherein the multiplexer unit of the transceiver module is a bit-wise multiplexer unit that is configured to multiplex bits of the first 10G transmission signal with bits of the second 10G transmission signal.

19. The system of claim 18, wherein the multiplexer unit of the transceiver module further comprises:
a first clock data recovery unit configured to recover clock and data of the first 10G transmission signal; and
a second clock data recovery unit configured to recover clock and data of the second 10G transmission signal.

20. The system of claim 18, wherein the demultiplexer unit of the transceiver module is a bit-wise demultiplexer unit that is configured to demultiplex bits form the 20G receive signal.
